(19) United States
(12) Patent Application Publication
(10) Pub. No.: US 2014/0050045 A1
(43) Pub. Date: Feb. 20, 2014

(54) Bench Mixer Improvements

(71) Applicants: Richard Hoare, Love Cove (AU); Nicholas Roseby, Bulli (AU); Mark Thomas, Leichhardt (AU)

(72) Inventors: Richard Hoare, Love Cove (AU); Nicholas Roseby, Bulli (AU); Mark Thomas, Leichhardt (AU)

(73) Assignee: Breville Pty Limited, Botany,NSW (AU)

(21) Appl. No.: 14/001,168

(22) PCT Filed: Feb. 22, 2012
(86) PCT No.: PCT/AU2012/000162

§ 371 Date: Oct. 30, 2013

(30) Foreign Application Priority Data
Feb. 23, 2011 (AU) 2011900613

(51) Int. Cl. A47J 43/07; A23G 9/22

(52) U.S. Cl. CPC A47J 43/0711; A23G 9/224
USPC 366/206; 366/343; 62/340

(57) ABSTRACT

An electric bench mixer has a base, a column and a pivoting head. The tilt angle of the head and the configuration of the blades are optimalised to provide a wiping action of the blades against the interior of the ball as the head is pivoted. An ice cream making bowl and blade are also disclosed.

### FIELD OF THE INVENTION

The invention relates to food mixers and more particularly to electric bench mixers and their accessories.

### BACKGROUND OF THE INVENTION

Electric bench mixers are well known. A bench mixer generally comprises a base with a turntable for supporting a mixing bowl and a column for supporting a pivoting mixing head that is adapted to receive one or sometimes two food mixing tools or other accessories.

For safety reasons and to minimise unwanted ejection of food from the bowl, pivoting of the mixing head in some devices causes the motor that rotates the mixing blades to turn to shut off. However, even systems of this kind can result in excessive ejection of food from the mixing blades while they are still turning.

Aspect of the present technology also concern an ice cream making bowl and scraper blade, in particular, said ice cream making accessories being optimised for an epicyclic mixing head.

### OBJECTS AND SUMMARY OF THE INVENTION

It is an object of the invention to provide a pivoting mixing head, the pivoting of said head causing the device's motor to stop at an optimised angle.

It is another object of the present invention to provide a mixing blade and cooperating bowl that minimise food ejection from the mixing bowl. In preferred embodiments, the blade flexibility, shape and bowl shape are optimised for a threshold angle of the mixing head.

It another aspect of the invention, an ice cream making bowl and cooperating scraper blade are provided.

### BRIEF DESCRIPTION OF THE DRAWING FIGURES

In order that the invention be better understood, reference is now made to the following drawing figures in which:

FIG. 1 is a side elevation, partially cross sectioned, illustrating a mixer, bowl and blade in accordance with the teachings of the present invention;

FIG. 2 is a perspective view of a hinge spindle, micro switch and switch activator associated with the mixer of the present invention;

FIG. 3 is a side elevation, partially cross sectioned depicting the mixer of FIG. 1 with the pivoting head rotated to the motor cut-off angle;

FIG. 4 is a side elevation, partially cross sectioned, illustrating an ice cream making bowl and cooperating scraper blade;

FIG. 4a is a cross sectional view through the ice cream making bowl shown in FIG. 4;

FIG. 5 is an illustration of the bench mixer shown in FIG. 3 with the head rotated to the cut-off angle;

FIGS. 6, 7 and 8 are top, front and side views of a mixing blade;

FIG. 9 illustrates a cross section of a mixer, bowl and mixing blade;

FIG. 10 illustrates a cross section of a mixer, bowl and mixing blade with the head tipped to its threshold;

FIG. 11 illustrates a cross section of a mixer, bowl and mixing blade where the edge of the blade maintains contact with the bowl as the head is tipped.

### BEST MODE AND OTHER EMBODIMENTS

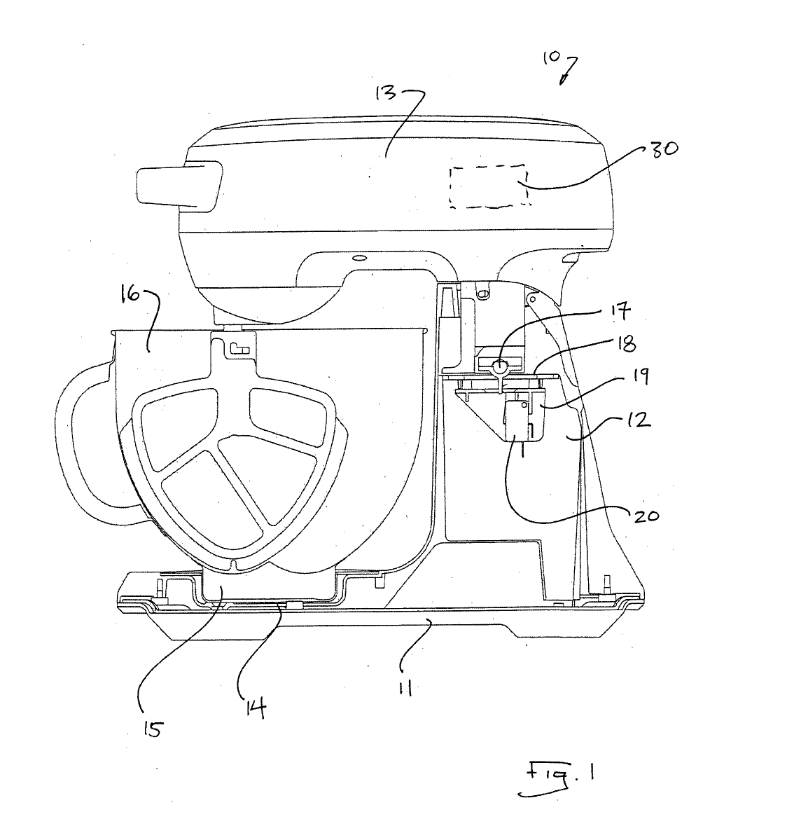

As shown in FIG. 1, a bench mixer 10 comprises a base 11, a generally hollow and integral, vertical column 12 and pivoting head 13. In this embodiment, the base ii further comprises a receptacle 14 for receiving a generally cylindrical bowl base 15. The union between the bowl and the stand base employs a clockwise engagement bayonet. In this example, the male component is integral with the bowl base and has three protrusions that engage with the receptacle to immobilise the bowl. The bowl base 15 is integral with the mixing bowl 16. Within the interior of the column 12 there is located a hinge spindle 17, a horizontal shelf 18, a micro switch mounting bracket 19 and a micro switch 20.

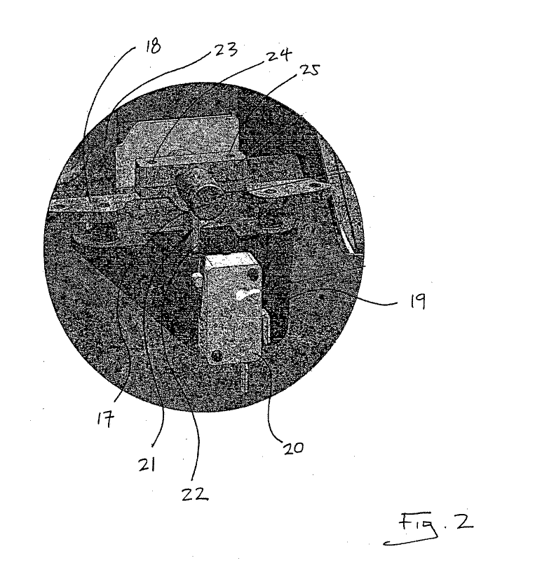

As shown in FIG. 2, a horizontal hinge spindle 17 is supported for rotation within the interior of the column 12. In this example, a switch activator 21 is clamped around or otherwise affixed to the rotating hinge spindle 17. The radial extension or finger 22 of the switch activator is shown pointing downward and depressing the contact of the (for example) normally open micro switch 20. Thus, in this orientation, corresponding to the working position of the head 13, the contact of the micro switch 20 are closed and thus power is able to be supplied to the motor that drives the mixer's blades or rotating accessories. In this example, the downward pivoting of the head 13 is limited by an internal horizontal shelf 18. The shelf 18 limits the motion of the head's chassis 23. In this example, the switch activator 21 is provided in two parts that are held together by a pair of fasteners 24, 25, located to either side of the spindle 17. The micro switch mounting bracket 19 is affixed, from below, to the shelf 18. The mounting bracket orients the micro switch adjacent to the switch activator.

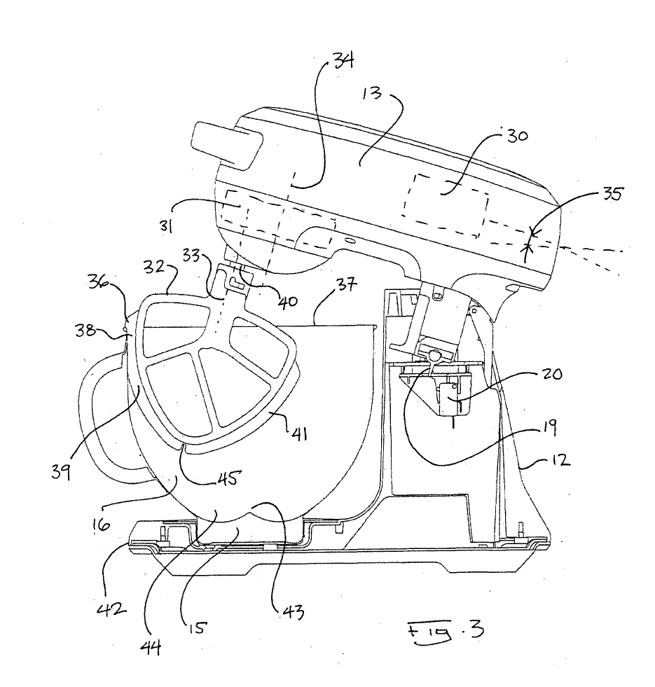

As shown in FIG. 3, a rotational lifting of the head 13 causes a rotation of the switch activator 19 in unison with the pivoting head, thus allowing the contacts of the switch or micro switch 20 to open and thus prevent power from being supplied to the motor 30. In this example, the mixing head 13 further comprises an epicyclic gear box 31 thus, the motor 30 drives the mixing blade 32 in rotation about its own axis 33 and simultaneously about a second or central axis 34. As illustrated, the switch activator cut off power to the motor 30 at a head angle 35 of 10-12 degrees. At a 10-12 degree cut-off angle 35, a mixing blade and more particularly a forward flexible edge 36 of the mixing blade 32, just clears the upper rim 37 of the mixing bowl 16. As shown, an upper portion 38 of the flexible edge 36 is still in contact with and bent or flexed by the inside of the bowl 16 while that portion 39 of the flexible edge below the bent upper portion 36 is not in contact with the interior of the bowl 16. Continued lifting or pivoting of the head will bring the lower parts of the mixing blade 32 into contact with the inner rim area of the mixing bowl 16. Thus, the flexible edge 36 undergoes a wiping action against the bowl 16 as it is rotating and retracted, thus reducing kitchen mess, particularly inadvertent ejection of food from the bowl 16. It should be noted that the aforementioned wiping motion of the mixing blade 32 relative to the bowl 16 pertains specifically to the motion of the blade when both the shaft of the blade 40 and an edge of the blade 38, 41 are in forward most orientation that is, as far as possible from the stand 12 (or alternately as close as possible to the forward portion or front of the mixer 42).

It can also be seen in FIG. 3 that the mixing bowl 16 further comprises an integral mixing bowl base 15 located below the interior of the bowl. The centre of the bottom of the interior of the bowl 43 is raised, thus producing a circular gulley 44 in which the rotating blade 32 travels in its epicyclic movement. The bowl further comprises an integral, single handle. The handle provides leverage for ease of pouring. The vertical arrangement of the handle makes it easier to operate tools that aid in removing the contents of the bowl when compared with horizontal handles that often reside within close proximity to the lip of the bowl. The single vertical handle also facilitates engagement of the bayonet coupling between the bowl and the base of the stand. Also illustrated is a notch 45 located between the flexible edges 36, 41 of the blade 32. The notch 45 allows the edges to flex independently.

As shown in FIG. 4, the bench mixer 13 is adapted to cooperate with an ice cream making bowl 50. The ice cream making bowl 5o comprises an outer shell 51, preferably with cylindrical, extended base portion 52 and an inner liner 53. The space 54 between the shell 51 and the liner 53 is filled with a re-freezable refrigerant material, i.e. a re-freezable gel, vinyl-coated silica gel, hydroxyethyl cellulose, propylene glycol or the like. The bowl is chilled before use and remains useful long enough to make a batch of ice cream. The bottom of the liner 55 is flat. The side walls 56 of the liner are tapered to conform with and cooperate with the tapered edges 57 of a scraper blade 58. The outward tapering from base to bowl lip are advantageous for mixing ice cream because this configuration promotes distribution of the ice cream up the walls, thus reducing the amount of cooling time required by displacing the ice cream mixture over a greater cooling surface area. The taper also allows pivoting of the head without removal of the scraper blade. This allows the removal of material from the blade as it rides up the wall of the bowl before breaching the bowl lip. The corner 59 between the side walls 56 and the flat bottom area is radiused 55 to conform with and cooperate with the radiused corners 56 at the bottom of the ice cream scraper blade. A central portion of the flexible and flat bottom area 55a comprises a partial or full notch 55b.

The interior space 54 also contains a thermal distributor 60 that completely surrounds the liner 53. As shown in FIGS. 4 and 4a, the thermal distributor 60 comprises a tapered ring or collar of aluminium sheet material that has been pleated or corrugated so as to increase its surface area and provide substantial surface contact with the tapered sides of the liner 56.

As suggested by FIG. 4, the scraper blade 58 is generally flat, and symmetrical about its longitudinal axis. In accordance with the epicyclic motion of the scraper blade, the edges 61 of the blade make alternating periodic contact with the liner. This motion provides a high scraping velocity and promote the development of a thin crystal forming region adjacent the liner during ice cream processing. Particularly with respect to an open air vessel that does not use a compressor or refrigerated housing, the amount of time required to transform the mixture into ice cream is important. The present configuration advantageously reduces the processing time when compared to prior art devices. The configuration of the bowl and blade in conjunction with the planetary action of the mixing head allows a thin layer to remain in contact with the walls of the bowl for about 2 revolutions before that portion of the bowl is again contacted by the scraper blade. The present arrangement provides creamy texture because it inhibits the formation of ice and chunks while still maintaining a high overall contact time.

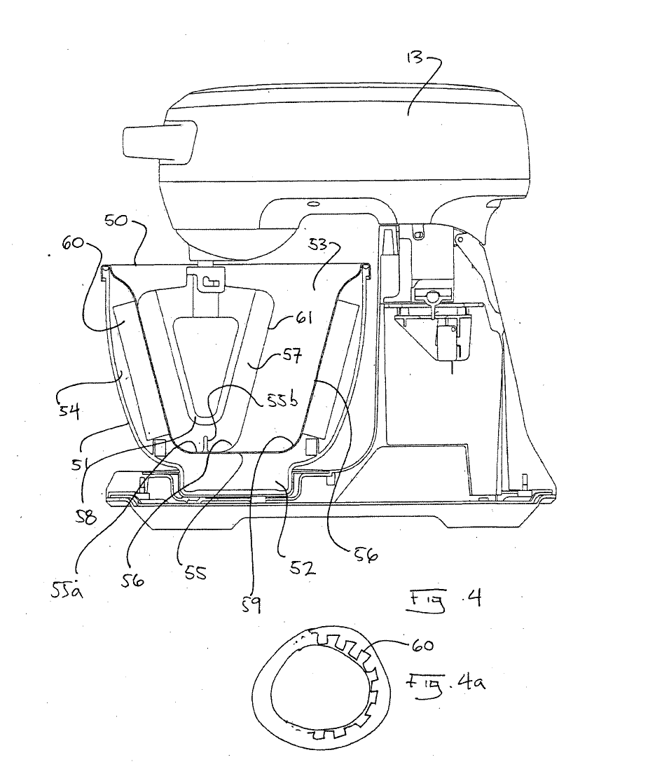

As shown in FIG. 5, the cooperation of the tapered sides of the liner with the tapered, flexible edges 61 of the scraper blade make it possible to withdraw the scraper blade 58 by tilting the head 13, without having to remove the blade 58 from the head. As shown in FIG. 5, the edges of the blade are flexible enough to bend when encountering the side walls of the bowl during removal. A central opening 62 in the scraper blade body reduces the surface area of the blade and therefore the amount of ice cream that will stick to the blade during removal. The opening also promotes greater folding of the ice cream mixture. This avoids driving large volumes of an uncooled mixture above the lip of the bowl. Thus the opening contributes to less disruption of the path followed by the ice cream mixture as the mixture cools. This avoids unnecessary formation of ice and chunks in the mixture. In this example, a bayonet type mounting 63 is used between the output shaft and the ice cream mixing blade.

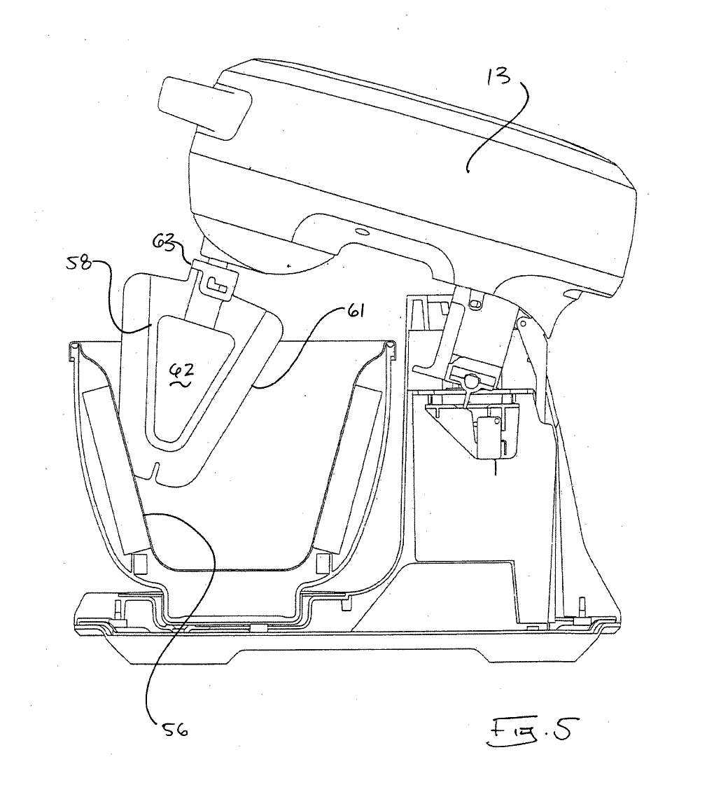

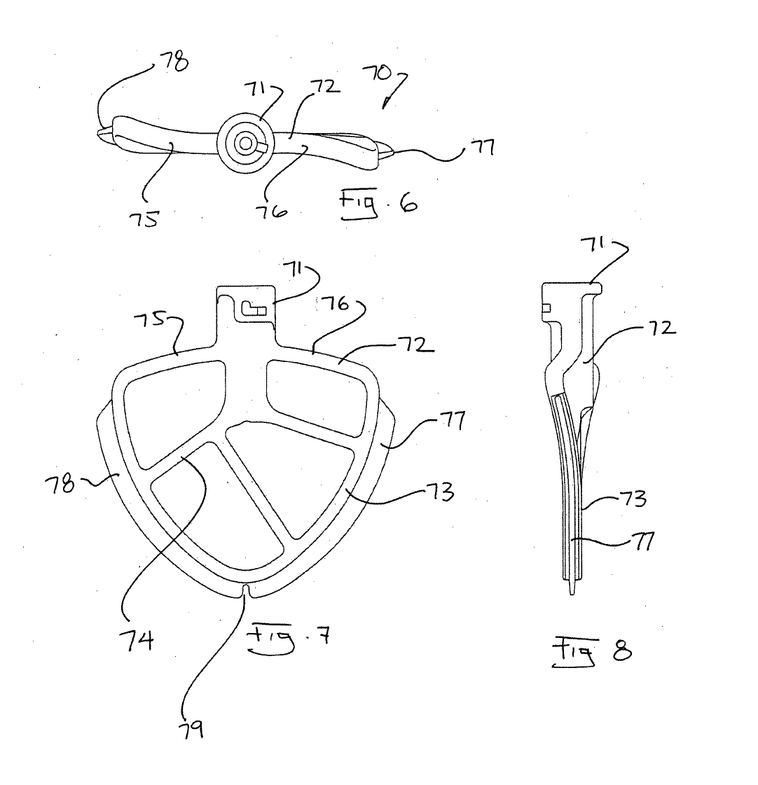

As shown in FIGS. 6, 7 and 8, a general purpose mixing blade 70 comprises a bayonet coupling 71 that is integrally moulded into a relatively hard polymeric body 72. The body 72 has two curved descending limbs 73, a network of internal stiffening ribs 74 and a pair of upper arms 75, 76 from which descend the curved sides 73. The blade is co-moulded to incorporate a softer polymeric edge 77, 78. A gap 79 is located between the lowest extremity of each of the edges 77, 78, allowing the edges to flex independently. As shown in FIG. 8, the limbs 73 and the edges 77 are twisted or slightly twisted along the axis of rotation of the blade.

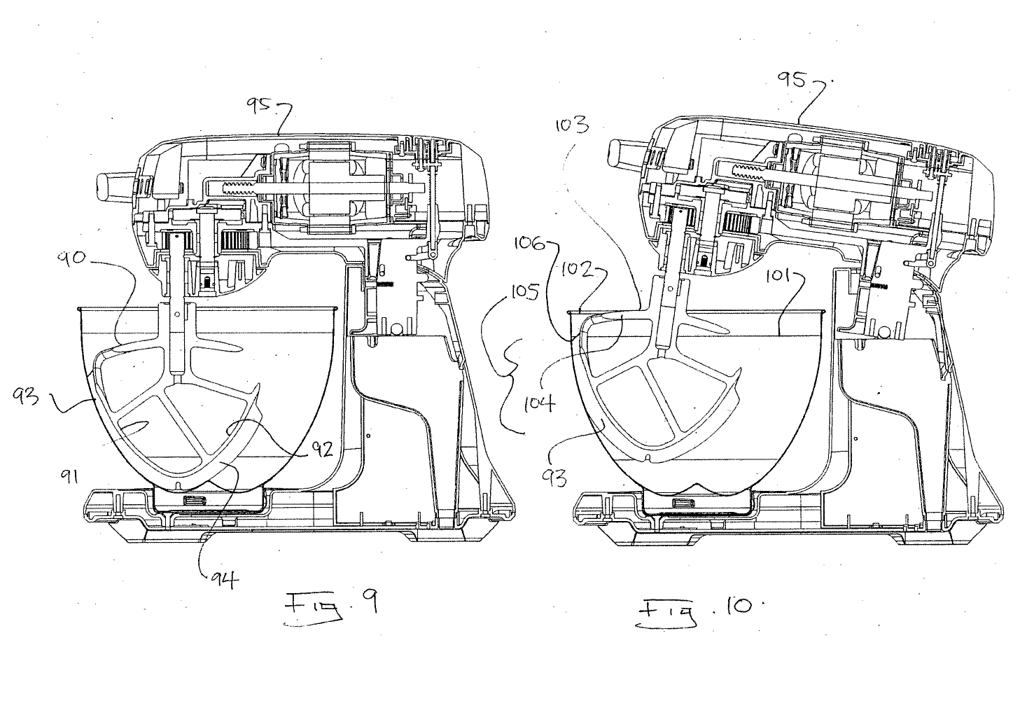

In one preferred embodiment, as shown in FIG. 9, a general purpose mixing blade 90 of the type depicted and discussed with reference to FIGS. 6, 7 and 8 has a pair of curved descending limbs 91, 92 formed from a rigid polymer and carry co-moulded softer polymeric scraping edges 93, 94. As suggested by FIG. 9, the shape of a descending limb 91 and its softer scraping edge 93 conforms to the curvature of the bowl in those places where the edge makes contact with the bowl when the epicyclic mixing head 95 is in its lowermost position.

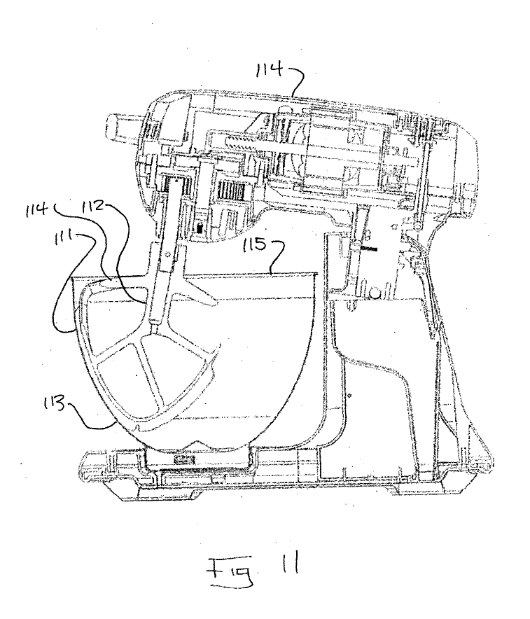

In conventional prior art mixing devices of this kind, practically any tilting of the mixing head 95 will cause an intentional loss of power to the motor that drives the epicyclic gear box and therefore the mixing tool. In other prior art devices, the motor must be turned off before the mixing head is tilted. In order that at least a partial of removal of food from the mixing blade 90 can occur before the blade is withdrawn from the bowl by the tipping action of the head, the device as depicted in FIG. 10, allows a tipping or lifting of the mixing head, for example, by eight degrees. It will be understood that the eight degree threshold is dependent on the geometry of the blade and bowl. As shown in FIG. 10, the combination of head and bowl have a tilting threshold 101 in the form a perimetral boundary that is located a distance below the upper rim 102 of the mixing bowl. In order that food not be ejected from the rotating blades as the head 95 is tilted, the switch or micro switch arrangement as previously discussed with reference to FIGS. 1, 2 and 3 causes the motor to turn off when the high point 103 of the upper limb 104 of the mixing blade is approximately at the same vertical height as the upper rim 102 of the mixing bowl. In this orientation, an upper portion 105 of the flexible edge 93 can still make contact with the bowl and thereby cause removal of food from that portion of the flexible edge 93. It will be observed that when the high point of the upper limb 103 is level with the upper rim 102 of the bowl, the uppermost extent of the flexible edge 93 is no higher than the bowl's tilting threshold 101.

As shown in FIG. 11, in preferred embodiments, the flexible edge 111 of a mixing blade 112 can maintain full length contact with the bowl 113 as the head 114 is tipped. This allows the full length of the blade 111 to be wiped clean on each rotation until such time as the tilting threshold has been reached and the motor turns off. In this example, the tilting threshold is met when the upper limb of the mixing blade is about level with the upper rim 115 of the bowl 113.

While the present invention has been disclosed with reference to specific details of construction and materials, these should be understood as having been made by way of example and not as limitations to the scope of the invention.

What is claimed is:

1. A bench mixer, having a base, a vertical column and a pivoting head, wherein:
the column has an interior in which is located a hinge spindle;
the hinge spindle supporting a switch activator that rotates in unison with the pivoting head;
a switch being located adjacent to the switch activator;
the switch activator cutting off power to the motor, by cooperating with the switch, when a head angle of the pivoting head reaches a tipping threshold that promotes a wiping of an edge of a mixing blade against a bowl as the head is tipped.

2. The bench mixer of claim 1, wherein:
the tipping threshold is when an upper limb of the mixing blade reaches an upper rim of the bowl.

3. The bench mixer of claim 2, wherein:
the pivoting head carries an gear box that provides an epicyclic motion to the blade and the bowl has a circular gulley in which the blade travels in the epicyclic motion.

4. The bench mixer of claim 3, wherein:
the blade has a flexible edge that undergoes a wiping action against the mixing bowl as it is retracted from the mixing bowl.

5. The bench mixer of claim 4, wherein:
the blade has edges that are twisted along an axis of rotation of the blade.

6. An ice cream making bowl for a bench mixer, comprising:
an outer shell and an inner liner, a space between the outer shell and inner liner being filled with a refrigerant material;
the bottom of the liner being flat and the side walls of the liner being tapered to conform to and cooperate with a scraper blade.

7. The bowl of claim 6, wherein:
the space also contains a ring-like thermal distributor being pleated to achieve surface contact with the liner.

8. In combination, the bowl of claim 6, and further comprising:
a mixer for interlocking with the bowl, the mixer having one or more blades with an epicyclic motion.

9. An ice cream making blade for a bench mixer with and epicyclic mixing head, the blade comprising:
a body with a flat bottom edge area and tapering side edges that are flexible;
the blade having a central opening.

10. The blade of claim 9, wherein:
the blade has a bayonette mounting.

11. The blade of claim 9, wherein:
the blade is an ice cream making blade that is cooperatively wiped against the liner as the blade is withdrawn from the bowl by the pivoting action of a pivoting head.
